(19) United States
(12) Patent Application Publication
(10) Pub. No.: US 2003/0018572 A1
(43) Pub. Date: Jan. 23, 2003

(54) Method enabling a bid caller to send an invitation to bid to one or several selected providers

(76) Inventors: Dominic Beschle, Basel (CH); Frank Deecke, Basel (CH); Andreas Kuefer, Basel (CH)

Correspondence Address: BLANK ROME COMISKY & MCCAULEY, LLP, 900 17TH STREET, N.W., SUITE 1000, WASHINGTON, DC, 20006, US

(21) Appl. No.: 10/247,329

(22) Filed: Sep. 20, 2002

Related U.S. Application Data
(63) Continuation of application No. PCT/CH00/00197, filed on Apr. 4, 2000.

(51) Int. Cl. G06F 17/60

(52) U.S. Cl. 705/37

(57) ABSTRACT

Method enabling a bid caller (4) to send an invitation to bid to one or several providers (3) selected from among those offering the type of goods and/or services sought on an electronic invitation to bid distribution platform (1), said platform being accessible to the bid caller through a first telecommunication network (2), wherein:

said platform conveys said invitation to bid to said selected providers,

said providers have the possibility of accepting or declining said received request for invitation to bid,

the name and address of said bid caller (4) are transmitted by said platform only to said providers who have accepted said invitation to bid,

the transmission of said details is billed by said platform only to all of said providers that have accepted said invitation to bid.

This application is a continuation application of PCT/CH00/00197 filed on Apr. 4, 2000, the contents whereof are included by reference.

### FIELD OF THE INVENTION

The present invention concerns a method of electronic commerce (e-commerce) enabling a bid caller to send an invitation to bid to one or several selected providers. The present invention also concerns a method for administering a computer platform as well as a computer data carrier in which a program for implementing the method is stored.

### RELATED ART

Over the past couple of years, Internet has become a widely used tool for conducting commercial transactions between remote partners. Two kinds of applications can usually be distinguished: on the one hand, applications involving a commercial provider and a private consumer, known by the term B2C (Business to Consumer) and, on the other hand, applications between commercial companies, designated by the term B2B (Business to Business).

Many Internet sites for example are known that offer to sell products or services according to different methods. For example, sites are known that regroup the offers of several providers and to which Internet users can connect in order to purchase the desired goods or services. An advantage of these sites is, on the one hand, that they regroup disparate offers and, on the other hand, that they allow the purchasers to establish a trust relationship with a single partner rather than with a plurality of potential providers.

This type of site requires from the providers that they make available a clear catalogue of services or goods that the customers can then directly order. Although different software tools have been developed to enable the providers to offer online and easily update a catalogue generated directly from their internal database, these sites are poorly adapted for selling goods and/or services for which a cost estimate or an individual offer has to be prepared according to the bid caller's wishes and needs. In particular, these sites are poorly adapted for selling services and goods at a negotiated price.

Furthermore, certain sites propose innovating selling mechanisms, for example through auctions. This type of service has two disadvantages: first, the time required for participating to an auction is rather considerable so that this service does not answer the expectations of professional buyers. Secondly, it does not allow several individualized offers to be compared.

Furthermore, sites of the directory type are known that contain a list of products or of services of providers and to which the bid callers can connect to conduct a transaction. These sites are generally financed either through renting advertising streamers or through a subscription paid by the providers for their products or address to appear in the directory. This method is thus not very attractive for the providers who have to pay a fixed contribution even if no bid caller is interested in their offers or whose offer is swamped amid the offers of other providers.

A solution of this type is for example proposed in U.S. Pat. No. 5,664,115 (Fraser) that describes a method wherein several concurring providers can store in a common database a list of offered goods. Potential buyers can access the data in this database by indicating the criteria of interest. A computer program supplies the buyers' name and address to the providers whose offers correspond to the indicated criteria.

Other methods are known in which the providers have to pay to the operator of an electronic transaction platform an amount that is proportional to the amount of the transactions effectively conducted through the platform. A fee is thus only due if a transaction is performed. For transactions involving considerable amounts, the commission paid to the platform operator is however dissuasive for the provider.

Other e-commerce methods exist in which the providers have to pay to the platform operator an amount each time a potential bid caller selects their address (“pay per click”) or each time their address is displayed (“pay per view”). The number of a bid caller's promptings, and thus the anticipated budget to be listed on such a platform, is very difficult to evaluate; furthermore, this method puts the providers at the mercy of “spammers” that can easily select an address with the only aim of generating costs.

Generally, these methods of known type do not allow the bid caller to send an individualized invitation to bid to several providers for a personalized offer.

It is an aim of the invention to propose an e-commerce method that is improved over the methods of the prior art.

In particular, it is an aim of the present invention to propose an e-commerce method that is more attractive for the providers of goods or services, as well as a method enabling the bid callers to send simultaneously to a plurality of carefully selected providers a personalized invitation to bid.

It is another aim of the invention to propose an e-commerce method in which the providers can themselves at any time control or even completely avoid the costs incurred.

### BRIEF SUMMARY OF THE INVENTION

According to the present invention, these aims are achieved by means of a method and a platform according to the characteristics of the corresponding claims, preferred embodiments being furthermore described in the dependent claims and in the description.

In particular, these aims are achieved by means of a method enabling a bid caller to send an invitation to bid to one or several providers selected from among those offering the type of goods and/or services sought on an electronic invitation to bid distribution platform, said platform being accessible to the bid callers through a first telecommunication network, wherein said platform conveys said invitation to bid to said selected providers, said providers having the possibility of accepting or declining said received request for invitation to bid, the name and address of said bid caller being transmitted by said platform only to said providers who have accepted said invitation to bid, said transmission of details being billed by said platform to all of said providers that have accepted said invitation to bid.

This method thus has the advantage for the provider that costs are incurred only when he receives an invitation to bid and effectively wishes to know the bid caller's name and address in order to submit a bid. Offered goods or services in which no one is interested will not generate any costs; also, the provider can decide at any moment to reduce or even cut the incurred costs simply by declining the received invitations to bid.

This method further has the advantage for the bid callers that they can effect in a single operation and without costs an invitation to bid for a complete and individual offer with several selected providers.

This method further has the advantage that no particular equipment or software is required at the providers' or at the bid callers'. The method can be used without initial costs by any user having a computer with Internet access and an ordinary navigation software.

### DESCRIPTION OF THE DRAWINGS

The invention will be better understood with the aid of the description given by way of example and illustrated by the attached figures, in which:

FIG. 1 shows a diagram illustrating diagrammatically the data flux in a first embodiment of the invention.

FIG. 2 shows a flux diagram illustrating the operations necessary for issuing an invitation to bid according to the invention.

FIG. 3 shows a flux diagram illustrating the operations necessary for answering an invitation to bid according to the invention.

FIG. 4 shows a diagram illustrating diagrammatically the data flux in a second embodiment of the invention.

FIG. 5 shows a diagram illustrating diagrammatically the data flux in a third embodiment of the invention.

FIG. 6 shows a first mask presented to a bid caller according to the inventive method.

FIG. 7 shows a second mask presented to a bid caller according to the inventive method.

FIG. 8 shows a third mask presented to a bid caller according to the inventive method.

FIG. 9 shows a fourth mask presented to a bid caller according to the inventive method.

### DETAILED DESCRIPTION OF THE INVENTION

Although the following description relates more particularly to the specific case of a transaction platform accessible via Internet, the one skilled in the art will understand that the invention can also be applied to other types of networks, in particular in networks supporting the WAP (Wireless Application Protocol) protocol for transactions between mobile users.

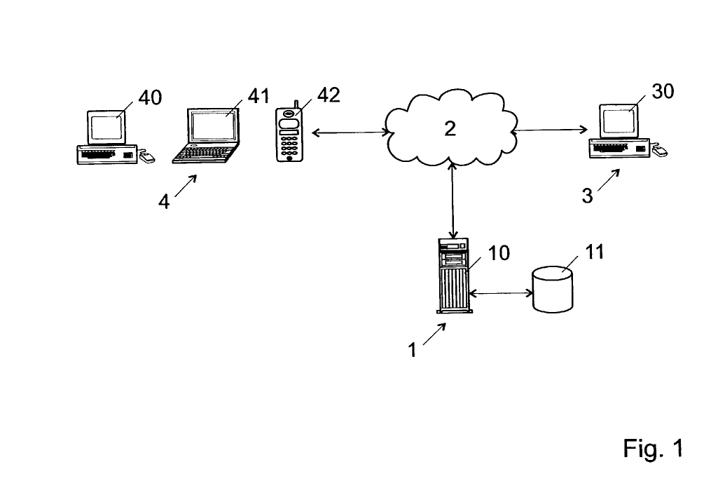

The system illustrated in FIG. 1 comprises a platform 1 administered by an operator and comprising for example one or several servers 10, for example an http or WAP server or a group of interconnected servers, as well as a database 11 containing a catalogue of providers 3 and of goods and/or services offered by these providers, as well as a list of users 4 inscribed in the system.

The provider catalogue comprises for each provider a record with several fields allowing a user to find easily and according to different criteria the appropriate providers. Each record preferably contains at least he following indications:

The provider's domain of activity, for example the economic branch. The different domains of activity proposed are preferably organized hierarchically in the database in several category levels, the terminology adopted for the principal categories being preferably defined by the operator of the platform 1. In a preferred embodiment, the providers can themselves create or propose new categories. Each provider can be recorded in one or several domains of activity.

The regions in which the provider 3 offers his goods and/or services. Each provider can be active on a local, national or international level. The region can for example be indicated by a name or a list of names of geographic regions or by a number corresponding for example to the telephone area code of the region. Preferably, each provider has the possibility of being recorded in one or several proposed regions, for example in a hierarchical menu.

Preferably, the provider's company name, which can possibly be complemented by a logo or by other indications that can be added for example against remuneration.

Preferably, a description in free text entered preferably by the provider himself in a field of determined length, for example 200 characters.

Preferably, one or several key-words defined by the provider and enabling him to be found more easily among the other providers in the database 11.

Preferably, certain personal choices of the provider, notably his preferences regarding delivery of the offer requests (used channel, regrouping or not of the offers, etc.).

The data concerning the providers 3 in the database 11 are preferably entered by the providers themselves, for example by means of an appropriate HTML form on the Internet site of the operator of the platform 1. In this case, the operator merely controls the contents of the entered data and ensures in particular that the providers record themselves in the correct category. Programs and measures of known type can additionally be implemented to fight “spamming”, i.e. the repeated and abusive entering of a provider in a multitude of irrelevant categories.

The data can however also be entered by the platform's operator, for example from data proposed by the providers by e-mail, by fax, by telephone, by postal mail or by any appropriate communication means. In a preferred embodiment of the invention, certain data are entered by the operator and complemented by the data entered directly by the providers 3.

The data in the database 11 can preferably be accessed online through a telecommunication network 2 of the Internet type for example. Preferably, the server 10 prepares dynamic data sheets prepared for the users according to their requests.

The providers 3 can for example be craftsmen proposing different types of services or tradesmen wishing to sell products or services. The provider catalogue contains at least a certain number of providers offering individualized services after establishing a personalized cost estimate according to the customer's needs. The providers 3 are preferably connected to the platform 1 through the first telecommunication network 2, for example of the Internet type.

A plurality of users 4, called hereafter and in the claims “bid callers”, can access the server 10 and the contents of the database 11 through the second telecommunication network 2, preferably of the Internet type, and by means of terminal devices 40, 41, 42, for example by means of a personal computer, a palmtop, a portable telephone etc., enabling them to connect to the network 2 and display by means of known navigation software the contents of the WEB pages or the WAP cards prepared by the server 10.

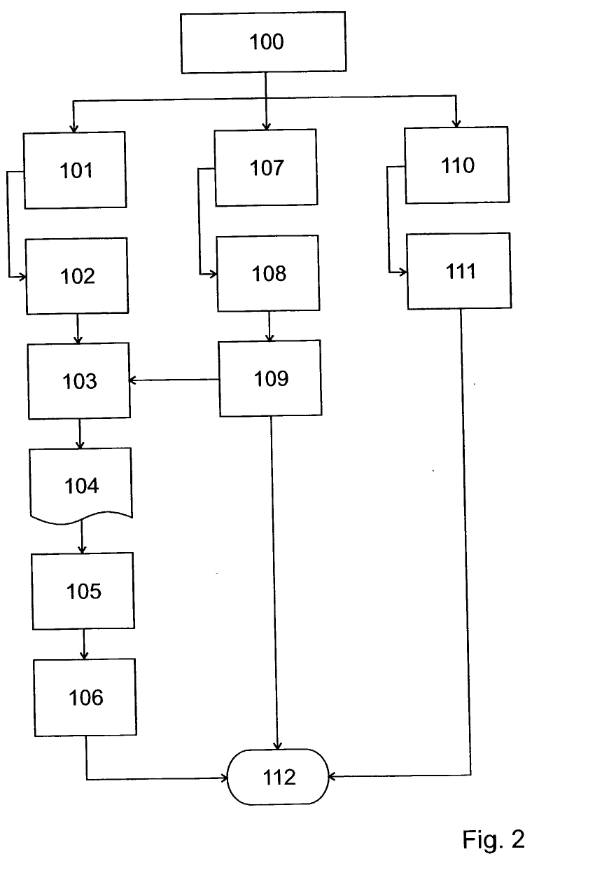

The steps of the process 100 enabling a bid caller to select one or several providers in the database 11 and to send them an invitation to bid shall now be seen with the aid of the FIGS. 2 and 6 to 9.

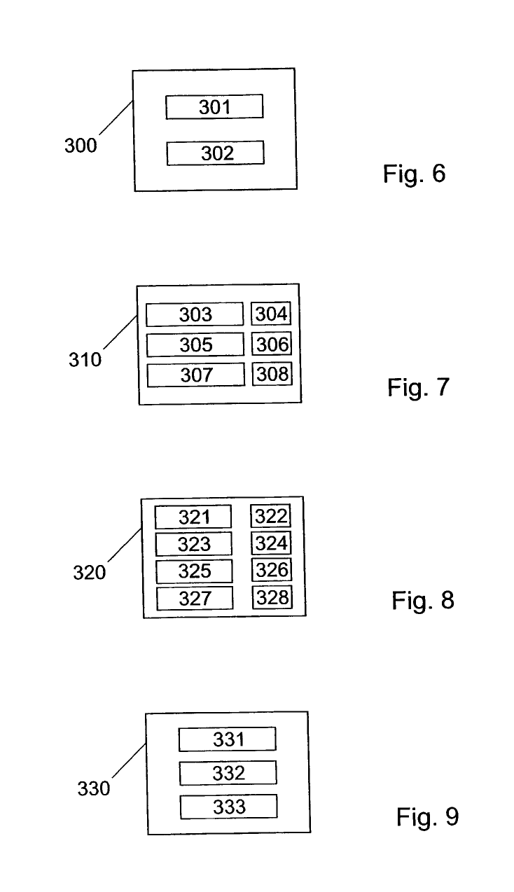

A bid caller having arrived at the site of the platform 10 creates a new invitation to bid by selecting a corresponding option (step 101). FIG. 6 illustrates by way of example the page 300 then proposed to him. This page enables him to identify himself by entering a user identity in a field 301 and a confidential password in a field 302. Other identification methods, for example by means of personal chip-cards and/or biometric data (finger prints, voice, iris or retina motifs etc.) can also be used in the framework of this invention.

Once the bid caller has been correctly identified, i.e. when the identity introduced corresponds to a user whose details are known by the platform 1, he is able to access a page (not represented) enabling him to indicate the type of sought provider, i.e. if the sought company must be active locally, regionally, nationally and/or internationally (step 102). In a subsequent step 103, a page 310 represented diagrammatically in FIG. 7 enables one or several provider search criteria to be entered into one or several fields 303, 305, 307 and one or several Boolean operators connecting these criteria to be entered in one or several fields 304, 306, 308. Other search masks, for example of the type used by search engines or directories on Internet, can also be proposed to the bid caller 4 for searching providers. The steps 102 and 103 can furthermore be regrouped in a single process on a single page.

After having entered the wished search criteria, the bid caller 4 obtains during step 104 a list of providers, represented diagrammatically in FIG. 8 and generated by the server 10 from the search criteria entered by the bid caller and the data in the database 11. For each provider 321, 323, 325, 327 corresponding to the entered criteria, the displaced result page preferably indicates the provider's name, possibly his address, and possibly other data entered by the provider in the database 11. The list of providers 321, 323, 325, 327 is alphabetical or, in a preferred embodiment, corresponds to the relevance as compared to the different criteria entered by the user.

Against each provider there preferably is a box to tick 322, 324, 326, 328 enabling the bid caller to indicate that he wishes to select the provider indicated to send him an invitation to bid. This allows a manual selection from among the results supplied by the platform 1 (step 105).

Once the provider selection is completed, the bid caller creates the invitation to bid during stage 106 by means of the page illustrated by way of example in FIG. 9. This page enables him preferably to enter a deadline for the auction in a field 331, a category in the field 332 - this field preferably containing a default value obtained from the criteria entered by the bid caller during the selection—and a free text in a field of the memo type 333. Other indications can be provided optionally or compulsorily according to the embodiment, for example indications on the bid caller's geographic location, on the task to be carried out, partial identification data of the bid caller etc. Furthermore, the bid caller preferably has the possibility of enclosing a document or electronic text edited with a conventional word processing software as attachment to the invitation to bid form 330.

The data entered by the bid caller are then sent automatically by the platform 1 to the selected providers, through the communication channel chosen by the provider (step 112), for example e-mail, fax, postal mail, SMS (Short Message System) etc.

The bid caller 4 preferably has the possibility of saving the platform 1 or, in a variant embodiment, in his terminal device 40, 41 or 42, a prepared request and to reuse it or modify it subsequently (step 107). Preferably, he can thus save several requests and select in a list (step 108) the request he wishes to modify (step 109) or reuse. This characteristic notably enables bid callers that frequently conduct the same type of auctions not to have to re-enter every time the same data.

The bid caller furthermore preferably has the possibility of selecting a predefined auction template in a list proposed by the operator of the platform 1 (step 110) containing examples of current auctions, and to modify the chosen template if necessary (step 111) before sending it.

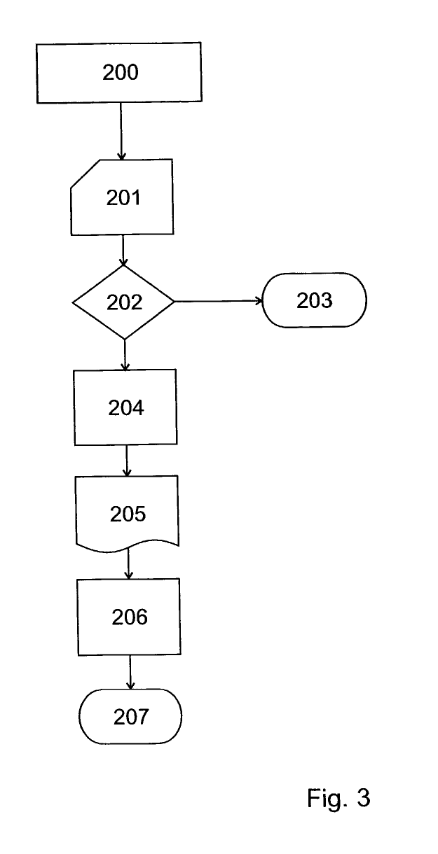

FIG. 3 illustrates the process 200 enabling a provider to answer a received invitation to bid from a bid caller. During the step 201, all the providers selected by the bid caller during the steps 103 to 105 receive, possibly through different communication channels, a copy of the invitation to bid entered by the bid caller. In a preferred embodiment, a least certain providers receive a copy of the invitation to bid by e-mail. Preferably, at least certain important providers use a proprietary computer software enabling the invitations to bid to be received and processed automatically or semi-automatically.

The received invitation to bid does not contain a complete identification enabling the bid caller to be identified, in order to prevent the provider from making direct contact with him.

During the step 202, the provider can chose to accept or refuse the invitation to bid, for example by clicking on the corresponding options in the HTML text of the received e-mail, or by sending a confirmation message by e-mail, fax, post, SMS etc. If a refusal is notified, a corresponding message is sent by the platform 1 to inform the bid caller (step 203). If the invitation to bid is accepted, the operator of the platform 1 bills an amount during step 204 to the provider 3. This amount is preferably a fixed sum or, in a variant embodiment, can depend for example on the category and/or the provider's type of record (regional, national, international) in the database 11; a quantity discount can furthermore be granted for important providers. The amount is preferably debited from a current prepaid account with the operator of the platform 1 or, in a variant embodiment, billed by means of a credit card or monthly bill.

As soon as the confirmation of acceptance of the invitation to bid and of the payment is received in the platform 1, the latter sends to the provider 3 during the step 205 the bid caller's details as they have been entered by him during the recording process in the database 11 or during the preparation of the invitation to bid. These details comprise for example preferably the name of the bid caller, his e-mail address, his postal address, his telephone and facsimile number etc.

The provider 3 then has the possibility of contacting directly the bid caller 4 during step 206 through the preferred communication channel. The provider's bid can thus remain confidential vis-à-vis the operator of the platform 1. In a preferred embodiment, one or several standardized templates for replying to invitations to bid are proposed by the operator of the platform 1 and for example attached to the transmission of the invitations to bid. In another preferred embodiment, the provider 3 also has the possibility of replying to the bid caller 4 through the platform 1 by loading an appropriate page containing an adapted reply form. The offer is then send to the bid caller by e-mail, post, fax, SMS etc. during step 207.

A software for receiving invitations to bid can be developed within the framework of this invention, allowing the providers to process more comfortably the received invitations to bid. The software can for example automatically filter the invitations to bid so as to exclude the invitations to bid answering certain predetermined criteria or extract the price indications from the provider's database to make the preparation of the bid easier.

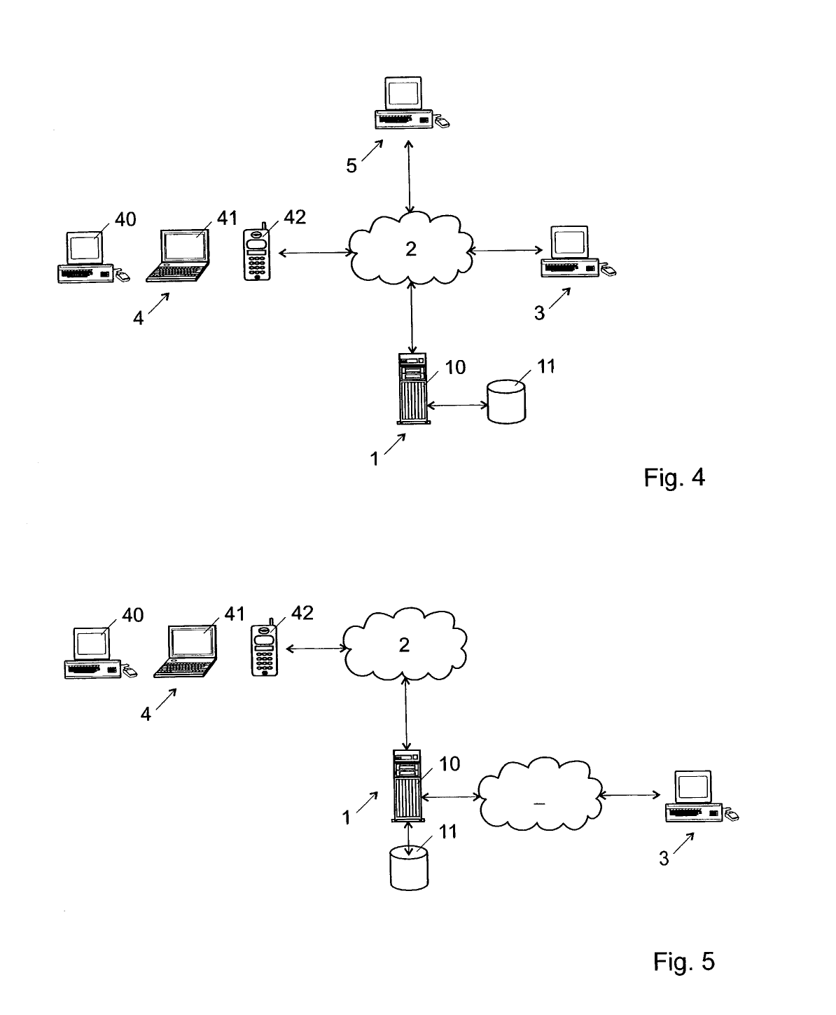

In order to enter into contact, the bid callers 4 and the providers 3 connect in the above example on the HTML site located on the server 10 of the operator of the platform 1. It is however possible to propose the same services on several servers 1, 5 and in several sites accessible through several different URL addresses, as illustrated in FIG. 4. In this example, an additional server 5 offers to the bid callers 4 and the providers 3 the same possibilities as the server 10, and preferably by accessing the same database 11, or a copy of this database, or an extract from the same database. It is thus possible to offer the services of the platform 1 on a plurality of servers, certain servers 5 being for example specialized for a type of goods and/or services or a particular region and accepting for example only records of providers in certain categories. The access to the complete bid caller database 11 by the server 5 in order to transmit it to the selected providers 3 is preferably billed, for example at a preferred rate, to the operator of the server 5. The operator of the server 5 can also bill the use of the necessary software or the access to the database 11.

It is also possible to access the platform 1 from the result page of a partner search engine of the operator of the platform 1. This solution also enables the bid caller to select the providers 102-104 by means of the usual search engine commands that may be more familiar to him. The result page of the search engine will then preferably be adapted to indicate to the bid caller which providers are recorded in the database 11 and to allow a selection from among them. In a variant embodiment, it is also possible to provide a direct link from the result page of the search engine to the page 320 illustrated in FIG. 8 and the exportation of provider lists to the server 10 of the platform 1.

Furthermore, as already mentioned, it is possible to connect the platform 1 with the bid callers 4 through a first telecommunication network 2, for example conform to the WAP (Wireless Application Protocol) protocol, and with the providers 3 through a second telecommunication network 6, for example of the Internet, ISDN or PSTN type, as illustrated in FIG. 5.

The present invention also concerns a computer data carrier, for example in the form of a magnetic and/or optical disk, that can be loaded in the computer server 10 and in which a computer program is stored that is capable of being executed by the server 10 for accomplishing the method described here above.

1. Method enabling a bid caller to send an invitation to bid to one or several providers selected from among those offering the type of goods and/or services sought on an electronic invitation to bid distribution platform, said platform being accessible to the bid caller through a first telecommunication network, wherein:
said platform conveys said invitation to bid to said selected providers,
said providers have the possibility of accepting or declining said received request for invitation to bid,
the name and address of said bid caller are transmitted by said platform only to said providers who have accepted said invitation to bid,
the transmission of said details is billed by said platform only to all of said providers that have accepted said invitation to bid.

2. The method of claim 1, said platform comprising an http server.

3. The method of claim 1, said platform comprising a WAP server.

4. The method of claim 1, said first telecommunication network being constituted by Internet.

5. The method of claim 1, said first telecommunication network being constituted by a mobile network conform to the WAP protocol.

6. The method of claim 1, said type of goods and/or services being indicated by said providers and comprising the economic branch in which said provider is active.

7. The method of claim 6, said indicated type of goods and/or services comprising the region in which said goods and/or services are offered.

8. The method of claim 1, said providers being selected by said bid caller by means of a navigation program displaying a page allowing one or several selection criteria to be entered.

9. The method of claim 8, said bid caller having the possibility of selecting in a first step a list of providers with the aid of said selection criteria, and then to eliminate in a second step one or several providers from among those proposed by said platform.

10. The method of claim 1, said bid caller having the possibility of editing a text for the invitation to bid, said text being sent to all the selected providers.

11. The method of claim 10, said text being edited with a word processor and enclosed as attachment with said invitation to bid.

12. The method of claim 1, said bid caller having the possibility of indicating in a field provided for this purpose the expiration date for submitting the bid.

13. The method of claim 1, said providers having the possibility of choosing through which channel they wish to receive said invitations to bid.

14. The method of claim 1, said providers receiving at least certain invitations to bid by e-mail.

15. The method of claim 1, said providers receiving at least certain invitations to bid by facsimile prepared by said platform with the aid of the indications entered by said bid callers.

16. The method of claim 1, said providers receiving at least certain invitations to bid via SMS prepared by said platform with the aid of the indications entered by said bid callers.

17. The method of claim 1, said providers receiving at least certain invitations to bid by postal mail prepared by said platform with the aid of indications entered by said bid callers.

18. The method of claim 1, said providers having the possibility of indicating by e-mail or by SMS to said platform that they accept or refuse said received invitation to bid.

19. The method of claim 1, said details of the bid caller including his e-mail address.

20. The method of claim 1, said details of the bid caller including his postal address.

21. The method of claim 1, said details of the bid caller including his telephone number.

22. The method of claim 1, said details of the bid caller including his facsimile number.

23. The method of claim 1, the transmission of said details being billed by said platform by debiting a prepaid account with the operator of said platform.

24. The method of claim 1, the transmission of said details being billed by said platform by charging a credit card.

25. The method of claim 1, said platform being accessible on several distinct servers in Internet.

26. Method for administering a platform for transmitting invitations to bid, comprising the following steps:
preparing, in response to a request from a bid caller, a page indicating a list of providers offering the type of goods and/or services required,
conveying an invitation to bid from the bid caller to the providers selected by said bid caller from among those indicated on said page,
receiving from at least one provider a notification of acceptance of the invitation to bid,
transmitting to said provider having accepted the offer the details of said bid caller,
billing the transmission of said details to said provider.

27. The method of claim 26, said page being a page capable of being reproduced by a WEB navigator.

28. The method of claim 26, said page being a WAP card.

29. The method of claim 26, comprising a step of receiving a text edited by said bid caller for the invitation to bid, said text being sent to all the selected providers.

30. The method of claim 26, said invitation to bid being transmitted to said at least one provider through the channel chosen by said at least one provider.

31. Computer data carrier capable of being loaded in a computer server and in which a computer program is stored that is capable of being executed by said computer server for accomplishing the method of claim 26 when said server is connected to a telecommunication server.
